(19) United States
(12) Patent Application Publication
(10) Pub. No.: US 2010/0058065 A1
(43) Pub. Date: Mar. 4, 2010

(54) EXTRACTING AUXILIARY DATA FROM A HOST SIGNAL

(75) Inventors: Mehmet Utku Celik, Eindhoven (NL); Aweke Negash Lemma, Eindhoven (NL); Jaap Andre Haitsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,588

(22) PCT Filed: Dec. 5, 2007
(86) PCT No.: PCT/IB07/54926

§ 371 Date: Jun. 4, 2009

(30) Foreign Application Priority Data
Dec. 11, 2006 (EP) 06125800.0

(51) Int. Cl. H04L 9/32

(52) U.S. Cl. 713/176

(57) ABSTRACT

The invention relates to extracting and embedding auxiliary data from and to a host signal. In an embodiment, the auxiliary data relates to remotely control of an application or a device, such as an interactive toy. Auxiliary data are extracted from a host signal, by periodically (32A-32C) with a predetermined first period searching a first section (33A-33C) of the host signal for a first watermark (34); and, upon detection of the first watermark, searching the host signal for a second watermark (35). In embodiments, information relating to timing and type of action to be performed by a remotely controlled device may be conveyed by the watermarks.

### FIELD OF THE INVENTION

The invention relates to extracting and embedding auxiliary data from and to a host signal. Moreover, the invention relates to a watermark detector, a watermark embedder, a signal and computer readable code.

### BACKGROUND OF THE INVENTION

Digital watermarking is generally used for purposes of protecting intellectual property rights. However, alternative applications of watermarked signals include communicating commands and control signals, or the equivalent, by the watermark. In a class of applications, digital watermarking is applied for event triggering or activating of remote devices. In an example, an interactive toy is adapted for reacting to a watermark embedded in a TV broadcast. For instance, the watermark embedded in the audio track or image data of a TV cartoon series may allow the toy to act in synch with the actions of the cartoon character seen on the screen.

In the U.S. Pat. No. 6,737,957 a system for using a watermark embedded in an audio signal to remotely control a device is disclosed. It is disclosed to use the watermark with a “time gate” device, where detection of the watermark opens a time interval within which a user is allowed to perform an action. This disclosure provides a solution to problems relating to synchronization of the device with the emitted signal, e.g. the audio track of a TV broadcast. However, for extracting information from the embedded watermark, elaborate processing is needed, which consumes power. A problem with the prior art is that the proposed schemes are not sufficiently power efficient for allowing continued operation of the controlled device. In particular, the prior art systems require constant processing of signals to detect any watermarks that may be embedded therein. If any part of the signal is not processed, any watermark embedded in that part will be missed and hence the user will not be allowed to perform actions associated with the embedded watermark.

The inventor of the present invention has appreciated that an improved detection scheme is needed for extracting auxiliary data from a host signal, and has in consequence devised the present invention.

### SUMMARY OF THE INVENTION

The inventors have had the insight that the watermarking system or scheme for event triggering or activating of applications or remote devices should be power efficient to maximize battery life of the application or device. Preferably, the invention alleviates, mitigates or eliminates one or more of the above or other disadvantages singly or in any combination.

According to a first aspect of the present invention there is provided, a method of extracting auxiliary data from a host signal, the method comprising:
periodically with a predetermined first period search a first section of the host signal for a first watermark;
upon detection of the first watermark, search the host signal for a second watermark.

The host signal is a signal having embedded therein a two-level watermark, the first level being embedded as a first watermark, and the second level being embedded as a second watermark relating to the first watermark. The first and/or the second watermarks may in embodiments be spread spectrum watermarks, however, any suitable type of watermarks may be applied.

In event triggering of an application, a watermark may be embedded in a discrete block of the content segment prior to the event. Typically, the watermarked segments occur infrequently. Continuous operation of the watermark detector would severely limit the battery life of the application. The invention is particularly but not exclusively advantageous since by only periodically searching a section of the host signal (a first section), the power duty-cycle is reduced. Moreover by providing a two-level detection of a watermark, where the second watermark is only searched upon detection of the first watermark, the scheme is rendered even more power efficient. Since a first watermark may be provided which may be detected with less elaborate processing, whereas any elaborate or substantially elaborate processing of the watermarked signal may be performed only for the second watermark. The need for elaborate processing is thereby minimized and therefore also the power consumption relating to processing of signals. The search of the host signal may comprise analyzing the host signal in order to detect the first watermark and possible also the second watermark. In the analysis features of the host signal may be derived or collected and detection is performed on those features or the detection may be done directly on the host signal. The detection may be done by use of a correlation method or other suitable way of detecting a watermark.

In an advantageous embodiment, the first watermark merely indicates the presence of a second watermark. The first watermark may thereby be designed with the main requirement that it is easily detectable. A simple first watermark may be provided, which does not require substantial elaborate processing.

In an advantageous embodiment, information conveyed by the second watermark is extracted upon detection of the second watermark.

In copy control applications, repeated identical control watermarks may be embedded in all parts of the content, thereby reducing the duty-cycle of the detector. However, in copy control applications, no timing requirements are typically present. To ensure, detection of a watermark with periodic detection, long watermarks may be embedded so as to ensure that a random segment will bear the mark. However, it typically requires complex detection to extract information from only a segment of a watermark such complex detection may imply reduction in power efficiency and battery life. Embodiments of the present invention is particularly but not exclusively advantageous for providing a watermark scheme which is both power efficient and can deal with infrequent watermarks requiring accurate timing of an action. In advantageous embodiments, information about timing of an action may be extracted from the first watermark and/or second watermark. As well as information about a type of action to be performed may be extracted from the second watermark. Information regarding timing and type of action may in various embodiments be extracted from the payload of the first and/or second watermarks or may be deduced from the structure of the first and/or second watermarks.

In an advantageous embodiment may the length of the first period be set larger than the length of the first section of the host signal, a reduced duty-cycle of the watermark detector may thereby be obtained.

In general embodiments may the first and second watermarks be used for remote control of an application, such as remote triggering of an effect or action. The signal for carrying the watermarks may be an audio signal or a visual signal.

According to a second aspect of the present invention there is provided a method of embedding auxiliary data in a host signal, the method comprising:
providing a first watermark and a second watermark;
embedding the first watermark having a first length into the host signal at a first position of the host signal;
embedding the second watermark having a second length into the host signal at a second position of the host signal, the second position being correlated to the first position.

The invention according to the second aspect is particularly but not exclusively advantageous since it facilitates embedding of a two-level watermark that may be extracted in a power efficient way.

In an advantageous embodiment, time information relating to a detector period and a detector duration of an associated watermark detector is provided, so that the length of the first watermark may be at least as long as the detector period, also referred to as the first period, and the detector duration, i.e. the duration of the first section of the host signal. Thereby ensuring that the watermark may be detected by a periodically operating detector.

In a third aspect of the invention there is provided a watermark detector implementing the method of the first aspect, and in a fourth aspect of the invention there is provided a watermark embedder for implementing the method of the second aspect.

In a fifth aspect there is provided a signal with a two-level watermark embedded therein, the first watermark indicating the presence of a second watermark, the first watermark being embedded at a first position of the host signal, the second watermark being embedded at a second position of the host signal, the second position being correlated to the first position.

The signal of the fifth aspect may be used for communicating the host signal from a device emitting control signals to a device or application receiving host signals.

Moreover, in sixth and seventh aspects are provided computer readable code arranged for causing a processor to perform the first and second aspects of the present invention.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates an embodiment of a toy in the form of a teddy bear which is remotely controllable by one or more media devices;

FIG. 2 schematically illustrates a strategy for extracting auxiliary data from a host signal;

FIG. 3 schematically illustrates a two-level watermark in relation to detector parameters, signal parameters and a time axis, along which the host signal is propagating;

FIG. 4 illustrates a flow diagram of steps to be taken in an embodiment for embedding auxiliary data in a host signal;

FIG. 5 schematically illustrates a watermark detector; and

FIG. 6 schematically illustrates a watermark embedder.

### DESCRIPTION OF EMBODIMENTS

Digital watermarking may be used to signal and trigger events from remote applications or devices. For instance, the watermark embedded in the audio track of a TV cartoon series may trigger a specific action on a toy in synch with the actions of the cartoon character. This application scenario has two distinct characteristics: i) the events (trigger points) are sparse, e.g. the toy will act only a few times during a 30 min. show. ii) the power is a limited resource, and batteries should last days if not weeks or even months. The power constraint makes it infeasible for the watermark detector to operate continuously. Moreover, the detection scheme should ensure that trigger points are not missed, or that the extraction of information is not so complex it jeopardizes power efficiency.

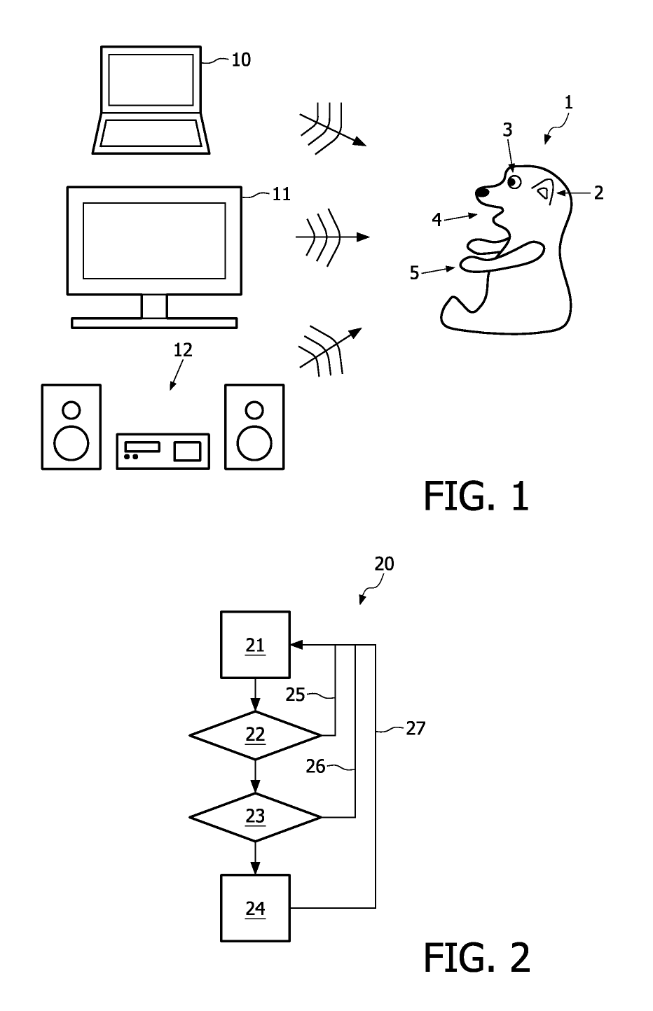

FIG. 1 illustrates an embodiment of a toy in the form of a teddy bear 1 which is remotely controllable by one or more media devices 10; 11; 12. In embodiments, may the teddy bear 1 comprise a microphone, possible inserted in the ear 2 or localized inside the toy close to the ear, so that the teddy bear is able to ‘hear’ an audio signal emitted from e.g. a computer such as in connection with running a computer application, e.g. in connection with visiting a home page, playing a game, watching Internet TV, etc. The audio signal may also be emitted from a TV set 11 or a music player 12. In an embodiment, may the teddy bear comprise a camera, e.g. localized in an eye 3 of the toy, for receiving a sequence of images of the received visual signal. Thereby the toy may be ‘able’ to see images emitted from a screen, such as a TV screen or a computer screen. In an example may the teddy bear comprise motor means for e.g. moving the mouth 4 or arms 5 in response to the received commands. The teddy bear may also include speaker means for being able to ‘sing’ or ‘talk’. The teddy bear also includes a processor implementing a watermark detector for receiving the host signal and extracting the watermark, and reacting in response thereto. In this Figure, reference is made to an interactive toy. The invention is, however, applicable to any kind of application or device, for example, for communicating commands to a computer application, to a home appliance, to consumer electronics, etc.

Certain advantageous embodiments of such a toy are disclosed in WO 2002/39739 (PHNL000591).

FIG. 2 schematically illustrates a strategy 20 for extracting auxiliary data from a host signal. The strategy is disclosed in connection with a watermark detector performing a number of steps.

An activator step 21 performs the action of periodically with a predetermined first period initiate a search for a first watermark of a first section of a host signal. In an embodiment, M seconds of data is searched, and the first period may be set as N seconds. The specific time duration may depend upon the specific application and it may for example only be needed to search milliseconds or it may even be needed to search minutes of a signal. The first section is searched in a first search step 22. In connection with this step, a watermark detector analyzes the host signal for the presence of a first watermark. The analysis or detection may be done online on the host signal, either directly on the signal or by deriving or collecting some features from the signal and perform the detection on those features. For instance, a band pass filter may be applied, the signal may be down sampled, the signal may be accumulated, etc. The detection may be done by means of correlation. In the event that the first watermark is not found 25 in the searched signal segment, the detector is returned to the activator step 21. In the activator step, the detector is inactive until the time interval of the first period has passed, where the detector reactivates for searching for the first watermark in a new first section of the host signal. The activation may be controlled by a timer.

In the event that the first watermark is found in the searched section of the host signal, the host signal is searched for a second watermark in a second search step 23. In an embodiment, O seconds of data is searched. The specific action 24 to be taken upon detection of the second watermark depends on the intended use of the watermark detector. Before different embodiments are further explained, the structure of the watermarks and the watermarked signal is addressed first.

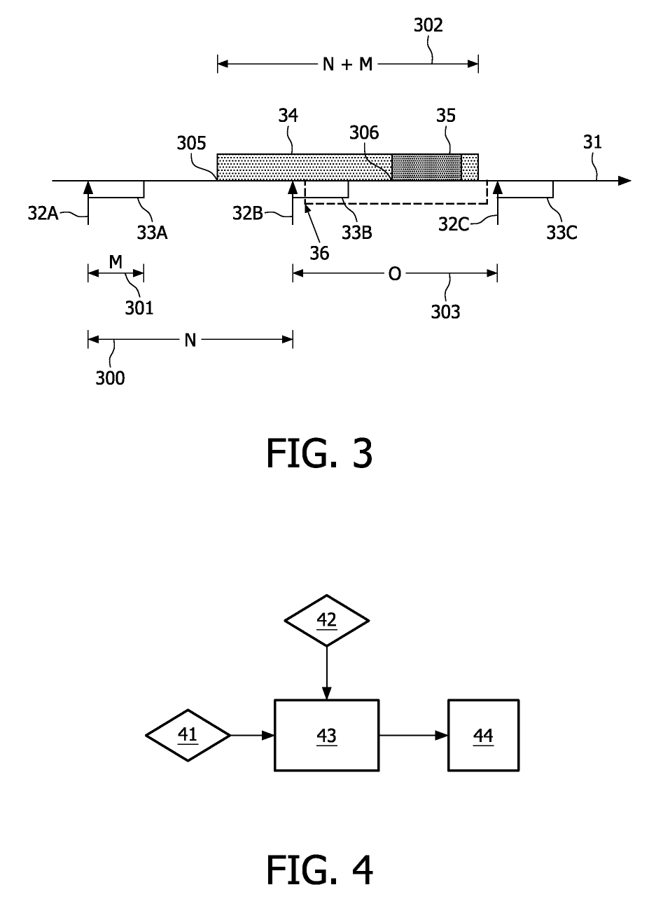

FIG. 3 schematically illustrates a two-level watermark in relation to detector parameters, signal parameters and a time axis 31, along which the host signal is propagating.

The host signal comprise a two-level watermark, the first watermark 34 indicating the presence of a second watermark 35, the first watermark being embedded at a first position 305 of the host signal, the second watermark being embedded at a second position 306 of the host signal, the second position being correlated to the first position.

Periodically 32A-32C, the detector is activated, and first sections 33A-33C of the host signal are searched at each time interval. If the first watermark signal is not found in the searched section of signal 32A; 32C, the detector is inactive until the time interval of the first period has passed. Upon detection of the first watermark signal 34, the host signal is searched for a second watermark 35, e.g. for O seconds, until a second watermark signal 35 is found or for a predetermined time. As soon as the first watermark has been detected, e.g. as indicated by the arrow denoted 36, the search of the second watermark is initiated, and the search of the first watermark may be stopped. The search of the second watermark is initiated already as soon as the first watermark is detected, otherwise in the event the second watermark 35 overlaps the first section 33B the second watermark may be missed. The first watermark signal is typically such that it is possible from a segment of the watermark to detect the presence of the first watermark, so as to ensure that it is not necessary to detect the beginning of the first watermark. The first watermark may be a repetitive watermark, e.g. the watermark pattern may be 3 seconds long and replicated 10 times, i.e. the first watermark is 30 seconds in total. Any arbitrary block of 3 second pattern in the 30 second watermark may have a complete pattern, possibly circularly shifted, and each block may be detected, e.g. be means of correlation, in an efficient manner using fast Fourier transform (FFT). A first watermark may thereby be provided where the detection is performed without the need for an alignment with the beginning of the first watermark.

In FIG. 3, the second watermark 35 is positioned inside the first watermark 34 and inside the duration of the period in which the first watermark is found, in general may the second watermark be place after either one of the end of the first watermark and end of the period in which the first watermark is found. This may be dictated by a protocol stating how much later it is placed.

The detection of the second watermark 35 may give rise to a number of actions.

In an embodiment, the first and second watermarks are used for remotely controlling a device. In this embodiment, at least two types of information may be conveyed by the first and second watermarks. A first type of information relates to a timing of an event of the remotely controlled device, whereas the second type of information relates to an action to be performed by the remotely controlled device.

A number of possible types of commands are listed below. The list is not exclusive and only provided for illustrating the large variety of possibilities of embedding and extracting commands into and from a host signal by means of the present invention. In the listed embodiments, the first watermark is a simple signal which is easy to detect, with the only purpose to indicate the presence of a second watermark, typically a nearby second watermark. This presence may be indicated by embedding a first watermark in the form of zero-bit watermark, or a first watermark which carries only a single or few bits. A single bit watermark may e.g. be embedded in order to ensure proper detection, such as the second watermark is only searched if the single bit payload of the first watermark is successfully extracted.

The presence of the first watermark is detected. The second watermark conveys information about timing of a single action. The timing information is extracted from the positioning of the second watermark. For example, the action is to be performed 5 seconds after detection of the second watermark.

The presence of the first watermark is detected. The second watermark conveys information about timing and type of the action. The timing information may again be extracted from the positioning of the second watermark. The type of action may e.g. be extracted from the duration of the second watermark. For example, the device may be able to perform five different actions, each action being correlated to five durations or lengths of the second watermark.

The presence of the first watermark is detected. The second watermark carries a single-bit payload, no timing is conveyed, and upon detection of the payload, the action is performed.

The presence of the first watermark is detected. The second watermark carries a multi-bit payload. The specific action to be performed is extracted from the payload. The action may be a simple action, or a more complicated action correlated to parameters derived from the payload.

The presence of the first watermark is detected. The second watermark carries a multi-bit payload. A time-stamp is extracted from the multi-bit payload.

The listed examples may be combined in any way possible. For example, the timing may be extracted from a position of the second watermark, the second watermark carrying a payload for conveying commands relating to actions. In another example, may the payload include both a time-stamp and commands relating to given actions. Etc.

The extraction of the payload may be performed by any suitable means, the extraction of a payload from a watermarked signal is known to the skilled person.

In an embodiment, the detection period or first period 300 of the detector is set to be N seconds, and it searches 301 M second of content, i.e. the first section of the host signal. In order to reduce the power as compared to continuous detection, N is set to be larger than M. The length of the first watermark is set to be at least N+M 302, so that a complete M second section of watermarked content will be analyzed by the detector regardless of the offset between the start points of embedding and detection. If the second watermark is not found within N+M seconds after the detection of the first watermark, it implies an error state. Either the first watermark detection was a false positive or the second level mark has been missed. In either case, the detector returns 26 to its earlier state of sleeping 21 and searching for the first watermark. If the first watermark signal is detected, a second section of O seconds 303 of the host signal is searched.

The power efficiency is provided by intermittent detection of a simple first watermark and even less frequent detection of a second watermark. The duty-cycle of the detection of the first watermark is:

D₁=M/N

The second watermark is searched for at most N+M seconds for each event. Assuming one event per T seconds on the average, the duty-cycle for the second watermark is:

D₂=½ (N+M)/T

Assuming M=5 sec, N=30 sec, T=300 sec, D₁=16.6% and D₂=6%

FIG. 4 illustrates a flow diagram of steps to be taken in an embodiment for embedding auxiliary data in a host signal. In a step 41 the host signal is received, and the first watermark and a second watermarks are received 42. In a next step 43, the first watermark is embedded into the host signal at a first position and the second watermark is embedded into the host signal at a second position. The host signal comprising the auxiliary data in the form of the first and second watermarks are outputted 44. The specific embedding process and the resulting signal with embedded watermarks are influenced by a number of factors depending on the specific application. For each application, a protocol is agreed upon dictating such parameters as the size and location of the first and second watermarks, the structure and type of the watermarks, whether a payload is embedded in the second watermark, information conveyed by payload, how to or if timing information is extracted, etc. Parameter and factors specified in such a protocol are naturally included in the embedding process.

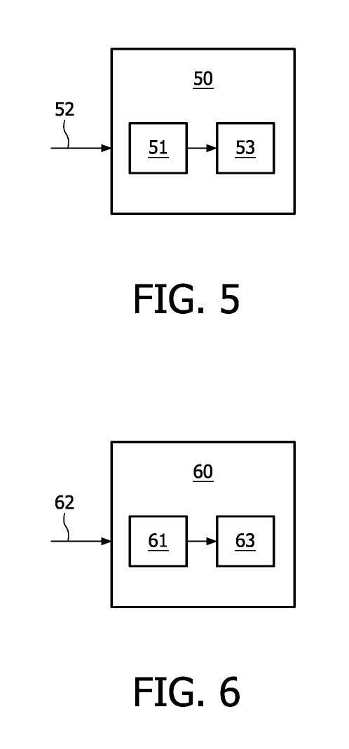

FIG. 5 schematically illustrates a watermark detector 50 comprising a first search unit 51 for periodically with a predetermined first period search a first section of the host signal 52 for a first watermark, and a second search unit 53 for upon detection of the first watermark, search the host signal for a second watermark. The watermark detector may comprise additional elements or units as well as the illustrated units may include additional functionalities, so as to provide a watermark detector capable of detecting a specific watermark.

FIG. 6 schematically illustrates a watermark embedder 60 comprising an input unit 61 for receiving a first watermark and a second watermark and an embedder unit 63 for embedding the first watermark having a first length into the host signal 62 at a first position of the host signal; and for embedding the second watermark having a second length into the host signal at a second position of the host signal, the second position being correlated to the first position. The watermark embedder may comprise additional elements or units, and the illustrated units may include additional functionalities, so as to provide a watermark embedder capable of embedding a specific watermark.

The watermark detector is typically located in the specific application, or in an application connected to the specific application. For example, the watermark detector is implemented in a processor located inside the teddy bear of FIG. 1. The watermark embedder is typically implemented in a computer system where the specific location depends on the specific use of the application. For example, the watermark embedder which is used for embedding the commands for use in the embodiment of FIG. 1 may be located at the production site of the show, at the broadcaster, at a company for performing the task of embedding commands in a signal, etc.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method of extracting auxiliary data from a host signal, the method comprising:
periodically (21) with a predetermined first period search (22) a first section (33A-33C) of the host signal for a first watermark (34);
upon detection (23) of the first watermark, search the host signal for a second watermark (35).

2. The method of claim 1, further comprising:
upon detection of the second watermark, extracts information conveyed by the second watermark.

3. The method of claim 2, wherein the second watermark conveys information about timing of an action.

4. The method of claim 2, wherein the second watermark conveys information about the type of an action.

5. The method according to claim 1, wherein the first watermark indicate the presence of a second watermark.

6. The method according to claim 1, wherein the second watermark carry a payload.

7. The method according to claim 6, wherein the payload include information about timing of a trigger action.

8. The method according to claim 6, wherein the payload include information about a type of trigger action.

9. The method according to claim 1, wherein the length of the first period is larger than the length of the first section of the host signal.

10. The method according to claim 1, wherein the first and second watermarks (34; 35) are used for remotely controlling a device (1).

11. The method according to claim 1, wherein the host signal is audio signal or a visual signal.

12. A method of embedding auxiliary data in a host signal, the method comprising:
providing a first watermark (34) and a second watermark (35);
embedding (43) the first watermark having a first length (302) into the host signal at a first position (305) of the host signal;
embedding (43) the second watermark having a second length into the host signal at a second position (306) of the host signal, the second position being correlated to the first position.

13. The method according to claim 12, further providing time information relating to a detector period (300) and a detector duration (33A-33C) of an associated watermark detector, and wherein the first length (302) is at least as long as the detector period and the detector duration.

14. A watermark detector (50) comprising
a first search unit (51) for periodically (21) with a predetermined first period search (22) a first section (33A-33C) of the host signal for a first watermark (34)
a second search unit (53) for upon detection of the first watermark, search the host signal for a second watermark (35).

15. A watermark embedder (60) comprising:
an input unit (61) for receiving a first watermark (34) and a second watermark (35);
embedder unit (63) for embedding the first watermark having a first length (302) into the host signal at a first position (305) of the host signal; and for embedding the second watermark having a second length into the host signal at a second position (306) of the host signal, the second position being correlated to the first position.

16. A signal with a two-level watermark embedded in the host signal, the first watermark indicating the presence of a second watermark, the first watermark being embedded at a first position of the host signal, the second watermark being embedded at a second position of the host signal, the second position being correlated to the first position.

17. Computer readable code arranged for causing a processor to perform the method of claim 1.

18. Computer readable code arranged for causing a processor to perform the method of claim 12.
